(19) United States
(12) Patent Application Publication
(10) Pub. No.: US 2025/0230881 A1
(43) Pub. Date: Jul. 17, 2025

(54) VEHICLE COMPONENT, SYSTEM, AND METHOD FOR PROTECTING A COIL WIRE OF A SOLENOID VALVE

(71) Applicant: ZF CV Systems Europe BV, Brussels (BE)

(72) Inventors: Stefan Knoke, Hannover (DE); Artur Keil, Hannover (DE); Nico Herzberg, Wedemark (DE); Arian Roolfs, Hannover (DE)

(21) Appl. No.: 19/021,648

(22) Filed: Jan. 15, 2025

(30) Foreign Application Priority Data
Jan. 16, 2024 (EP) 24152112.9

(51) Int. Cl. F16K 31/06; H01F 7/08

(52) U.S. Cl. CPC F16K 31/0675; H01F 7/081

(57) ABSTRACT

A vehicle component (10) has a solenoid valve (10). The solenoid valve (10) has a coil (11), having a coil wire (12), and a contact pin (30, 30′) for electrically contacting the coil wire (12). The contact pin (30, 30′) has a welding zone (32), at which the coil wire (12) is secured by a welded joint (33). The vehicle component (10) has a fixing arrangement (34) for the mechanical fixing of the coil wire (12) in a region (36) of the contact pin (30, 30′) which is at a distance from the welded joint (33).

### FIELD

The present disclosure relates to a vehicle component that has a solenoid valve, to an electropneumatic vehicle system, to a motor vehicle and to a method for reducing a risk of breakage of a coil wire of a solenoid valve. In particular, the present disclosure relates to devices, systems and methods that can be employed in commercial vehicles.

### BACKGROUND

Solenoid valves are used in many different ways in motor vehicles, especially commercial vehicles. They play an important role in pneumatic vehicle systems.

One area of application is the brake system of commercial vehicles. Here, solenoid valves are employed to regulate the pressure in the brake lines. They enable a quick and reliable response by the brakes, improving the safety and control of the vehicle. Electropneumatic shift transmissions, electropneumatic clutch systems, cleaning of vehicle sensors and air treatment are further illustrative areas of application.

Thus, solenoid valves can be employed in a large number of applications in commercial vehicles. They can contribute to improved performance, safety and environmental compatibility of vehicles.

Due to unavoidable vibration and shocks, there can be an increased risk of breakage for a coil wire of a solenoid valve. This applies especially in areas in which the coil wire rests against a metal part, and a relative movement between the coil wire and the metal part leads to weakening of the coil wire. This can lead to a reduction in the durability of the solenoid valve or of the vehicle component having the solenoid valve. Replacing the solenoid valve or the vehicle component that has the solenoid valve can be expensive and can lead to unwanted downtime of a motor vehicle.

### SUMMARY

It is the object of the present disclosure to provide an improved vehicle component, systems, or motor vehicles having a vehicle component of this kind, and methods which can reduce the risk of a repair-related outage of a motor vehicle by extending the life of a solenoid valve.

According to embodiments of the present disclosure, the object is achieved by a vehicle component, an electropneumatic vehicle system, a motor vehicle and a method as defined herein. The present disclosure also defines advantageous or preferred exemplary embodiments.

A vehicle component according to one embodiment has a solenoid valve. The solenoid valve has a coil, having a coil wire, and a contact pin for electrically contacting the coil wire. The contact pin has a welding zone, at which the coil wire is secured by a welded joint. The vehicle component has a fixing arrangement for the mechanical fixing of the coil wire in a region of the contact pin which is at a distance from the welded joint.

The vehicle component provides various technical effects and advantages. By way of the fixing arrangement, a relative movement between the coil wire and the contact pin is reduced or prevented at least in the region of the contact pin which is at a distance from the welded joint and in which the fixing arrangement fixes the coil wire. The risk of a relative movement between the coil wire and the contact pin, which may lead to weakening of the coil wire, is thereby reduced.

The fixing arrangement can advantageously be configured to support the coil wire in a form-fitting manner on the region of the contact pin which is at a distance from the welded joint.

By way of the form-fitting support, a relative movement between the coil wire and the contact pin in the region of the contact pin which is at a distance from the welded joint can be reduced. The risk of breakage of the coil wire on the contact pin is thereby reduced.

The fixing arrangement can advantageously have at least one shape feature, which is provided on the contact pin and is configured to support the coil wire in a form-fitting manner.

A shape feature of this kind makes it possible to reduce a relative movement between the coil wire and the contact pin without the need for additional substances or devices such as an adhesive or fastening elements separate from the contact pin. This offers weight advantages and allows efficient fixing.

The contact pin can extend along a direction of extent. An end portion of the coil wire can be wound around the contact pin, with the result that it runs around the direction of extent of the contact pin at least once or optionally at least twice. The fixing arrangement can be configured to reduce a relative movement between the coil wire and the contact pin at least along the direction of extent of the contact pin.

It is thereby possible to reduce the relative movement between the coil wire and the contact pin along the direction along which shocks can lead particularly easily to slipping of the coil wire relative to the contact pin in the absence of the fixing arrangement.

The contact pin can be designed as a sheet-metal part with two main surfaces and lateral surfaces connecting the latter, the area of which is in each case smaller than that of the main surfaces. The at least one shape feature can be formed on at least one of the lateral surfaces.

It is thereby possible to reduce the relative movement between the coil wire and the contact pin, particularly where, due to its particularly sharp curvature, the coil wire is subject to a particularly high risk of breakage in the case of a continued movement relative to the contact pin, e.g. in the case of vibration or other shocks.

The at least one shape feature can have at least one recess, through which the coil wire extends.

It is thereby possible to achieve form-fitting support of the coil wire on the contact pin by using at least one recess, which can be produced in a particularly simple and efficient manner. For example, the at least one recess can be produced in a cutting or non-cutting process. The at least one recess can be produced during the punching of the contact pin as a sheet-metal part from a metal sheet.

The at least one recess can be provided in a lateral surface of a contact pin designed as a sheet-metal part, wherein the lateral surface extends between the two main surfaces of the contact pin. The at least one recess can extend continuously from one main surface to the opposite main surface.

It is thereby possible to reduce the relative movement between the coil wire and the contact pin, particularly where, due to its particularly sharp curvature, the coil wire is subject to a particularly high risk of breakage in the case of a continued movement relative to the contact pin, e.g. in the case of vibration or other shocks.

The contact pin can have a first lateral surface and a second lateral surface, wherein the first lateral surface and the second lateral surface extend parallel to a direction of extent of the contact pin and between the two main surfaces. The at least one recess can include a first recess or a plurality of first recesses, which are formed on the first lateral surface, and a second recess or a plurality of second recesses, which are formed on the second lateral surface.

A relative movement between the coil wire and the contact pin is thereby further reduced. In addition, the fixing of the coil wire is made possible in a particularly simple way since the coil wire can be passed through recesses on opposite lateral surfaces of the contact pin.

The at least one recess can include a recess in the form of a notch.

It is thereby possible to achieve form-fitting support of the coil wire on the contact pin by using at least one recess in the form of a notch, which can be produced in a particularly simple and efficient manner.

The at least one recess in the form of a notch can have two oppositely inclined slot boundary surfaces. The two oppositely inclined slot boundary surfaces can extend continuously from one main surface to the opposite main surface of a contact pin designed as a sheet-metal part.

It is thereby possible to reduce the relative movement between the coil wire and the contact pin, particularly where, due to its particularly sharp curvature, the coil wire is subject to a particularly high risk of breakage in the case of a continued movement relative to the contact pin, e.g. in the case of vibration or other shocks.

The at least one recess in the form of a notch can have rounded or chamfered transitional surfaces adjacent to the slot boundary surfaces, e.g. a rounded or chamfered transitional surface between the two slot boundary surfaces and/or a further rounded or chamfered transitional surface between each of the slot boundary surfaces and a region, adjacent along the direction of extent of the contact pin, of the lateral surface in which the recess in the form of a notch is formed.

It is thereby possible to reduce the risk of damage to the coil wire even further and to reduce the risk of failure of the vehicle component.

The at least one recess in the form of a notch can have a recess width measured along the direction of extent of the contact pin. The recess width (e.g. a slot width) can be at least equal to a wire diameter of the coil wire. Alternatively or in addition, the at least one recess in the form of a notch can have a recess depth (measured relative to the lateral surface of the contact pin in which the recess is formed) that is at least equal to the wire diameter of the coil wire.

Particularly secure form-fitting support of the coil wire on the contact pin is thereby achieved. The risk of a relative movement between the coil wire and the contact pin is further reduced.

The fixing arrangement can have a plurality of mutually spaced recesses through which the coil wire extends. The plurality of mutually spaced recesses can be spaced apart from one another along a direction of extent of the contact pin. If the contact pin is designed as a sheet-metal part with two main surfaces and lateral surfaces extending between these, the plurality of mutually spaced recesses can be provided in at least one of the lateral surfaces and can be spaced apart from one another along a direction of extent of the contact pin.

Fixing at a plurality of positions along the direction of extent of the contact pin is thereby achieved, and a relative movement between the coil wire and the contact pin is further reduced. In addition, the fixing of the coil wire is made possible in a particularly simple way since the coil wire can be passed through different recesses.

The contact pin can have two main surfaces, a first lateral surface and a second lateral surface, wherein the first lateral surface and the second lateral surface extend parallel to a direction of extent of the contact pin and between the two main surfaces. The plurality of mutually spaced recesses can include a first sequence of a plurality of recesses, which are formed on the first lateral surface, and a second sequence of a plurality of recesses, which are formed on the second lateral surface.

Fixing at a plurality of positions along the direction of extent of the contact pin is thereby achieved, and a relative movement between the coil wire and the contact pin is further reduced. In addition, the fixing of the coil wire is made possible in a particularly simple way since the coil wire can be passed through different recesses on opposite lateral surfaces of the contact pin.

The contact pin can extend along a direction of extent, wherein the coil wire can run around the contact pin in a helical shape along the direction of extent.

An end portion of the coil wire which is welded to the contact pin via the welded joint can thereby be guided reliably to the welding zone.

The fixing arrangement can be configured to reduce or prevent a relative movement between the coil wire and the contact pin along the direction of extent.

It is thereby possible to efficiently reduce the relative movement between the coil wire and the contact pin along the direction along which, without the use of the fixing arrangement, there would be a risk of weakening of the coil wire due to a relative movement in the event of continued shocks.

The contact pin can have a contact pin width measured in a width direction running transversely to the direction of extent. In the region of the contact pin which is at a distance from the welded joint, the contact pin width can vary as a function of a position along the direction of extent.

It is thereby possible to form a shape feature which provides form-fitting support for the coil wire on the contact pin. In particular, the shape feature formed in this way can have at least one projection or at least one recess in a side wall of the contact pin.

In the region of the contact pin which is at a distance from the welded joint, the contact pin width can exhibit a nonmonotonic change.

It is thereby possible to form a shape feature which provides form-fitting support for the coil wire on the contact pin.

The vehicle component can be a vehicle component of an electropneumatic transmission system, of an electropneumatic clutch system, of an electropneumatic brake system, of an air treatment system, of an electropneumatic leveling system, of an electropneumatic air spring system or of an electropneumatic brake system.

It is thereby possible to reduce the risk that the life of an electropneumatic vehicle system of this kind is reduced by breakage of a coil wire.

The coil wire can be free from a sheath.

This reduces the risk of breakage of the coil wire by fixing by way of the fixing arrangement specifically for a solenoid valve with an unsheathed coil wire. A solenoid valve of this kind is typically more susceptible to breakage of the coil wire or some other weakening of the coil wire due to rubbing of the coil wire on the contact pin.

The fixing arrangement can be configured to fix the coil wire by the mechanical action of at least one shape feature of the contact pin on the coil wire without using different materials for fixing the contact pin and the coil wire.

It is thereby possible to reduce the risk of breakage of the coil wire in a particularly efficient way by fixing by way of the fixing arrangement.

According to another embodiment of the present disclosure, an electropneumatic vehicle system is provided which has the vehicle component according to one embodiment or one exemplary embodiment.

It is thereby possible to reduce the risk that the life of an electropneumatic vehicle system of this kind is reduced by breakage of a coil wire.

The electropneumatic vehicle system can have an electropneumatic transmission system, an electropneumatic clutch system, an electropneumatic brake system, an air treatment system, an electropneumatic leveling system, an electropneumatic air spring system and/or an electropneumatic brake system.

It is thereby possible to reduce the risk that the life of an electropneumatic vehicle system of this kind is reduced by breakage of a coil wire.

According to another embodiment, a motor vehicle is provided which has the vehicle component or the electropneumatic vehicle system according to one embodiment or one exemplary embodiment.

It is thereby possible to reduce the risk of an outage of the motor vehicle caused by breakage of a coil wire.

According to another embodiment, a method for reducing a risk of breakage of a coil wire of a solenoid valve of a vehicle component is provided. The solenoid valve has a contact pin. The contact pin has a welding zone. The coil wire is secured on the welding zone by a welded joint. The method includes mechanically fixing the coil wire in a region of the contact pin which is at a distance from the welded joint in order to reduce or prevent a relative movement between the coil wire and the contact pin in the region of the contact pin which is at a distance from the welded joint.

The method provides various technical effects and advantages. By way of mechanical fixing, a relative movement between the coil wire and the contact pin is reduced or prevented at least in the region of the contact pin which is at a distance from the welded joint and in which the fixing arrangement fixes the coil wire. The risk of a relative movement between the coil wire and the contact pin, which may lead to weakening of the coil wire, is thereby reduced.

The method can furthermore include forming at least one shape feature on the contact pin, wherein the at least one shape feature is configured to support the coil wire in a form-fitting manner. The mechanical fixing can include winding an end portion of the coil wire helically around the contact pin in such a way that the at least one shape feature supports the coil wire in a form-fitting manner.

A shape feature of this kind makes it possible to reduce a relative movement between the coil wire and the contact pin without the need for additional substances or devices such as an adhesive or fastening elements separate from the contact pin. This offers weight advantages and allows efficient fixing.

The mechanical fixing can include matching the winding of the coil wire around the contact pin to the at least one shape feature in such a way that the at least one shape feature assists the mechanical support of the coil wire wound around the contact pin.

It is thereby possible to reduce the risk of breakage of the coil wire in a particularly reliable way.

The method can be carried out by or with the vehicle component according to one embodiment or one exemplary embodiment, the electropneumatic vehicle system according to one embodiment or one exemplary embodiment, and/or the motor vehicle according to one embodiment or one exemplary embodiment.

Further optional features of the method and the respective effects achieved thereby correspond to the features and effects explained with reference to the devices and systems according to exemplary embodiments.

The vehicle component and the method according to exemplary embodiments can be employed in pneumatic vehicle systems of motor vehicles, in particular commercial vehicles. Electropneumatic shift transmissions, clutch systems, leveling systems, air spring systems, air treatment installations and brake systems of commercial vehicles are areas of application in which the vehicle component and the method can be employed to particular advantage.

### BRIEF DESCRIPTION OF THE DRAWINGS

Further advantages, features and details of the present disclosure will become apparent from the following description of preferred embodiments. Embodiments of the present disclosure are described below, in particular with reference to the figures. These do not necessarily illustrate the embodiments to scale. Where expedient for explanatory purposes, the figures are executed in schematic and/or slightly distorted form.

FIG. 1 shows a solenoid valve of a vehicle component according to one exemplary embodiment.

FIG. 2 shows a perspective partial view of the solenoid valve.

FIG. 3 shows a plan view of a contact pin of the solenoid valve.

FIG. 4 shows a perspective partial view of another configuration of the contact pin of the solenoid valve.

FIG. 5 shows a plan view of yet another configuration of the contact pin of the solenoid valve.

FIG. 6 shows a solenoid valve of a vehicle component according to another exemplary embodiment.

FIG. 7 shows a vehicle component having at least one solenoid valve.

FIG. 8 shows an electropneumatic vehicle system which has the vehicle component of FIG. 7.

FIG. 9 is a schematic partial illustration of a vehicle which has an electropneumatic shift transmission system.

FIG. 10 is a schematic partial illustration of a vehicle which has an electropneumatic shift transmission configured as an automatic shift transmission.

FIG. 11 is a schematic illustration of a vehicle which has an electropneumatic brake system.

FIG. 12 is a schematic illustration of a vehicle which has an electropneumatic clutch system.

FIG. 13 is a schematic partial illustration of a vehicle which has a leveling system.

FIG. 14 is a schematic partial illustration of a vehicle which has a pneumatic suspension system.

FIG. 15 is a schematic illustration of a brake system which has a plurality of modulators.

FIG. 16 is a schematic partial illustration of a vehicle which has an air supply installation.

FIG. 17 is a flow diagram of a method for reducing a risk of breakage of a coil wire of a solenoid valve.

FIG. 18 is a flow diagram of a production method for the solenoid valve.

### DETAILED DESCRIPTION

According to one embodiment of the present disclosure, a vehicle component which has a solenoid valve is provided. The solenoid valve has a configuration which reduces the risk of breakage of a coil wire of the solenoid valve.

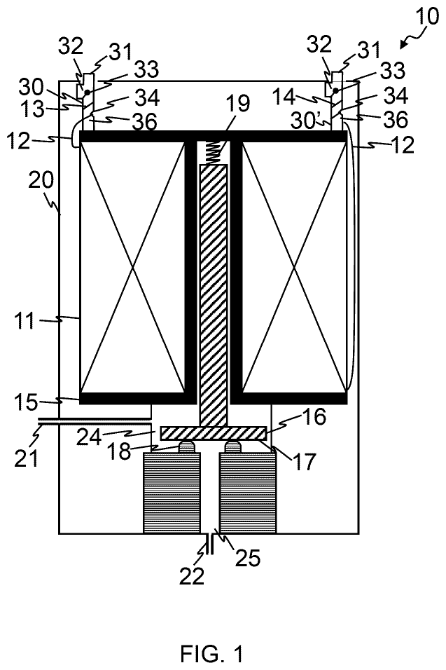

FIG. 1 shows a schematic illustration of a solenoid valve 10. By way of example, the solenoid valve 10 is illustrated as a 2/2-way valve but is not restricted to this number of ports and/or valve positions. The solenoid valve 10 has a coil 11. The coil 11 can be supplied selectively with power in order to move a sealing body 16 relative to a valve seat 18. When the coil 11 is energized, for example, the sealing body 16 can be moved relative to the valve seat 18 under the influence of a magnetic field generated by the coil 11 in such a way that a sealing surface 17 of the sealing body 16 is moved away from the valve seat 18.

For supplying power to the coil 11, the solenoid valve has a contact pin 30 and a further contact pin 30′. For electrical contacting of the solenoid valve in such a way that a flow of current through the coil 11 can be generated in a selective way, each of the contact pins 30, 30′ has a terminal region 31. The terminal region 31 is configured for electrically conductive connection to a conductor. The terminal region 31 can be configured as a connector. The further contact pin 30′ can have a configuration which corresponds to that of the contact pin 30. In the following description, therefore, reference is made principally to features of the contact pin 30, and the corresponding features can be implemented in an identical or similar way on the further contact pin 30′.

The coil 11 has a coil wire 12. The coil wire 12 has an end portion 13 and a further end portion 14. The end portion 13 is welded on to the contact pin 30 in a welding zone 32 of the contact pin 30 by way of a welded joint 33. The further end portion 14 is welded on to the further contact pin 30′ in a welding zone 32 of the further contact pin 30′ in a similar manner by way of a welded joint 33.

The solenoid valve 10 has a fixing arrangement for reducing or preventing a relative movement between the end portion 13 and a region 36 of the contact pin 30 which is at a distance from the welding zone 32 and in which the coil wire touches the contact pin 30. In the case of the solenoid valve 10 in FIG. 1, the fixing arrangement is configured in such a way that it is in the form of a shape feature of the contact pin 30. The shape feature can be designed as a slotted shape feature 34. In the region 36 of the contact pin 30, the coil wire 12 is supported in a form-fitting manner by the slotted shape feature 34. In this way, the risk that the coil wire 12 will slip along a direction of extent of the contact pin 30 is reduced, at least in region 36.

In the event of continued shocks affecting the solenoid valve 10, e.g. due to vibration of a chassis, slipping of the coil wire 12 in contact with the contact pin 30 can lead to weakening of the coil wire 12 at the end portion 13, and thus to an increased risk of breakage. Because the fixing arrangement provides form-fitting support of the coil wire 12, the risk of such slipping is reduced. The risk of a fault in the solenoid valve 10 is thus reduced. This, in turn, reduces the risk of failure of a pneumatic vehicle system having the solenoid valve 10 and/or of a motor vehicle having the solenoid valve 10 in terms of maintenance.

In order to support the coil wire 12 particularly securely in a form-fitting manner at the end portion 13 or at the further end portion 14, the shape feature formed on the contact pin 30 and/or the further contact pin 30′ can have a geometry which is matched to a diameter of the coil wire 12. For example, the slot or slotted recess 34 can have a depth and/or width which is at least equal to the diameter of the coil wire 12.

The coil wire 12 is advantageously an unsheathed coil wire 12, wherein a metallic material of the coil wire 12 rests directly on the contact pin 30. In the case of solenoid valves 10 with an unsheathed coil wire 12, the effect provided by the fixing arrangement, that of reducing or preventing a relative movement between the coil wire 12 and the contact pin 30 in the end portion 13, is particularly advantageous.

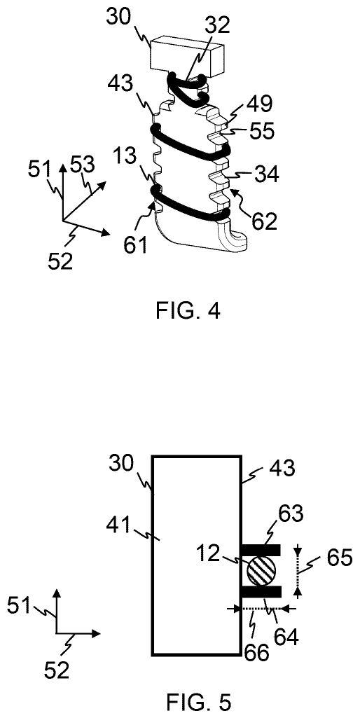

The end portion 13 of the coil wire 12 will extend around or wrap around the contact pin 30 at least once and optionally more than once, e.g. in the form of a helix. A gradient or pitch of the helix can be variable as a function of the position along a direction of extent of the contact pin 30. In the case of at least one of the turns around the contact pin 30, the coil wire 12 can be supported in a form-fitting manner in the end portion 13 by the slotted shape feature 34. In other configurations, the fixing arrangement can be configured in such a way that it supports the coil wire 12 in a form-fitting manner in each of at least two turns around the contact pin 30, as described in greater detail with reference to FIG. 4, for example.

As illustrated in FIG. 1, the solenoid valve 10 can be configured as a 2/2-way valve without being restricted thereto. The solenoid valve 10 can have a first port 21, which can be coupled directly or indirectly to a compressed gas source. The solenoid valve 10 can have a second port 22, which can be connected directly or indirectly to a pneumatic consumer, e.g. an air consumer of an electropneumatic transmission system, of an electropneumatic clutch system, of an electropneumatic brake system, of an air treatment system, of an electropneumatic leveling system, of an electropneumatic air spring system or of an electropneumatic brake system. Selective energization of the coil 11 to actuate the solenoid valve 10 leads to a movement of the sealing body 16 relative to the valve seat 18. In this way, the solenoid valve 10 can be switched between a first position and a second position. In the first position, for example, a first fluid space 24 fluidically connected to the first port 21 can be sealed off from a second fluid space 25 fluidically connected to the second port 22 when the sealing surface 17 rests on the valve seat 18. In the second position, due to the movement of the sealing surface 17 away from the valve seat 18, a fluid connection can be established between the first port 21 and the second port 22, wherein gas (e.g. air) can flow from the first fluid space 24 into the second fluid space 25 and/or from the second fluid space 25 into the first fluid space 24. The first port 21 and the second port 22 can be provided on a housing 20 in which the coil 11, the first fluid space 24, and the second fluid space 25 are arranged.

The solenoid valve 10 has a coil support 15, on which the coil 11 is arranged. The end portion 13 and/or the further end portion 14 can be led away radially from a coil form. Other ways of leading the end portions away (e.g. axially) can likewise be employed in the exemplary embodiments.

The solenoid valve 10 can be configured to bias the sealing body 16 into one of the valve positions. This can be accomplished by the action of gravity and/or by using a spring-elastic device 19. The solenoid valve 10 can thereby be biased into a normally closed position, for example.

The fixing arrangement, which is configured to support the coil wire 12 in a form-fitting manner on the contact pin 30 in an end portion 13 in such a way that the risk of slipping along the contact pin 30 is reduced can have various configurations. Irrespective of the specific configuration of the contact pin 30, the contact pin 30 can be designed as a sheet-metal part. A sheet thickness of the sheet-metal part can be from 0.5 mm to 10.0 mm, from 0.55 mm to 0.9 mm, or from 0.6 mm to 0.8 mm. A contact pin 30 configured in this way, including the shape feature provided thereon or the shape features provided thereon, can be manufactured efficiently, e.g. as punched parts. The contact pin 30 can be a tin plated sheet or can have a tin plated sheet.

The coil wire 12 can have a wire diameter of from 0.2 mm to 0.5 mm. The coil wire 12 can be a copper wire with a wire diameter of from 0.2 mm to 0.5 mm.

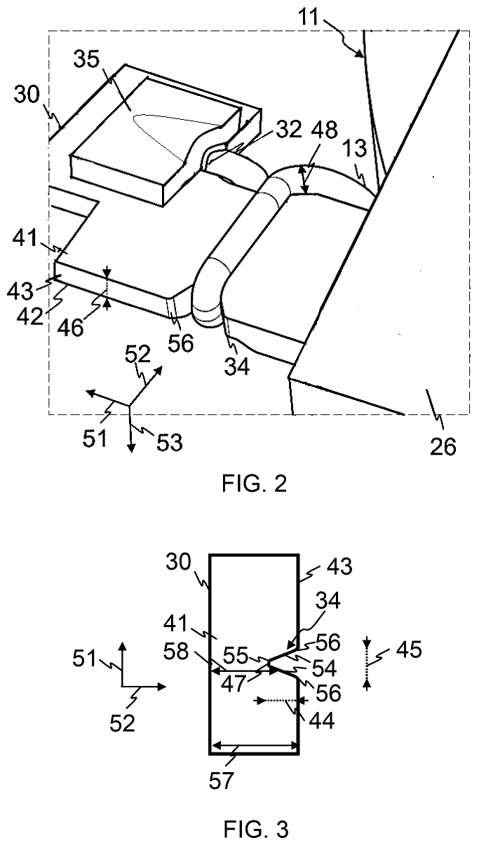

Various configurations of the contact pin 30 of the solenoid valve 10 are described with reference to FIGS. 2-5. The respectively described configuration features can also be present on the further contact pin 30′.

FIG. 2 shows a perspective partial view of the solenoid valve 10 according to one exemplary embodiment. The contact pin 30 extends along a direction of extent 51 as far as the terminal region 31 (not shown in FIG. 2). The direction of extent 51 can be defined by the direction along which the contact pin 30 has the terminal region 31 at one end and/or along which the contact pin 30 has its maximum extent. At the base end opposite the terminal region, the contact pin 30 is secured on a support 26. The support 26 can, for example, be connected integrally or in a fixed manner to the coil support 15 or to the housing 20 of the solenoid valve 10. The contact pin 30 is designed as a sheet-metal part, e.g. as a punched part. The contact pin 30 has a first main surface 41 and a second main surface 42, which is arranged opposite the first main surface 41. A lateral surface 43 extends along the direction of extent 51 and between the first main surface 41 and the second main surface 42. According to conventional terminology the two mutually parallel, largest, substantially flat surfaces of the contact pin 30 are understood as the main surfaces of the contact pin 30. Surfaces along a thickness direction 53 are understood as lateral surfaces.

Along the thickness direction 53, which is perpendicular to the first main surface 41 and to the second main surface 42, the contact pin 30 has a sheet thickness 46. The sheet thickness can advantageously be from 0.5 mm to 10.0 mm, from 0.55 mm to 0.9 mm, or from 0.6 mm to 0.8 mm.

The solenoid valve 10 can have a cover 35 for the coil wire 12. The cover 35 can cover the coil wire 12, e.g. at the welding zone 32. The cover 35 can be formed integrally with the contact pin 30.

The contact pin 30 has the slotted shape feature 34 at least along the lateral surface 43 which extends between the (larger-area) main surfaces 41, 42. As an option, there can be at least one further slotted shape feature for form-fitting support of the coil wire 12 on the further lateral surface of the contact pin 30, said further lateral surface being situated opposite the lateral surface 43. The at least one shape feature 34 for form-fitting support of the coil wire 12 in the end portion 13 leads to a width of the contact pin 30 that is defined along a width direction 52 being variable as a function of a position along the direction of extent 51 at least where the at least one shape feature 34 is provided on the contact pin 30. In particular, the width can exhibit a nonmonotonic change in order to reduce or eliminate the risk of movement of the coil wire 12 along the direction extent 51 by form-fitting support. Put another way, the slotted shape feature 34 may be a notch having a tapered profile extending inwardly from one or more of the lateral surfaces 43.

The coil wire 13 has a wire diameter 48. The wire diameter 48 can advantageously be from 0.2 mm to 0.5 mm. The slotted shape feature 34 has dimensions which are matched to the wire diameter 48 in such a way that the slotted shape feature 34 supports the coil wire 12 in a form-fitting manner in its end portion 13, namely in at least one region of the contact pin 30 which is spaced away from and at a distance from the welding zone 32. For this purpose, the slotted shape feature 34 can, for example, have a depth and/or a width which enables a wire to be routed completely through the slotted shape feature 34 without projecting beyond a plane defined by the lateral surface 43.

The slotted shape feature 34 can have at least one chamfered and/or curved transitional surface 55 in order to reduce or avoid sharp edges in the surroundings of the coil wire 12. It is thereby possible to further reduce the risk of breakage.

FIG. 3 shows a plan view of the contact pin 30 of the solenoid valve 10 according to one exemplary embodiment. The fixing arrangement has at least one slotted shape feature 34 on the lateral surface 43. The slotted shape feature 34 is dimensioned in such a way that the coil wire 12 is routed through the recess defined by the slotted shape feature 34 and supported in a form-fitting manner by the shape feature in the solenoid valve 10. The slotted shape feature 34 has at least one slot or notch. The slot extends inwardly from a plane defined by the lateral surface 43. The slot can be in the form of a notch. The slotted shape feature has two slot boundary surfaces 54 that slope toward one another and extend into the main surfaces 41, 42. The slot boundary surfaces 54 can each be substantially flat. The slot boundary surfaces 54 can be parallel to the thickness direction 53. The slotted shape feature 34 can have one or more transitional surfaces, which can be chamfered or curved in order to further reduce the risk of weakening of the coil wire 12 in contact with the contact pin 30.

The slotted shape feature 34 for form-fitting support of the coil wire 12 in the end portion 13 leads to a width of the contact pin 30 that is defined along a width direction 52 being variable as a function of a position along the direction of extent 51 at least where the at least one shape feature 34 is provided on the contact pin 30. This is illustrated by way of example in FIG. 3 for a contact pin width 57 and a further contact pin width 58.

The slotted shape feature 34 can advantageously have a transitional surface 55 connecting the slot boundary surfaces 54. The transitional surface 55 can be curved, e.g. in the form of a segment of a cylindrical surface, the center line of which is parallel to the thickness direction 53. Alternatively or in addition, the slotted shape feature 34 can have further transitional surfaces 56, which each connect one of the slot boundary surfaces 54 to a flat portion of the lateral surface 43. The further transitional surfaces 56 can have radii of curvature which are equal in magnitude but differ in direction in order in each case to connect one of the slot boundary surfaces 54 to a flat portion of the lateral surface 43. The further transitional surfaces 56 can each be curved, e.g. in the form of a segment of a cylindrical surface, wherein the center line of the cylinder segment surface is parallel to the thickness direction 53.

The slotted shape feature 34 can have further chamfered or curved transitional surfaces, e.g. in order to form a smooth transition between the slotted shape feature 34 into the main surface 41 and the further main surface 42.

The slotted shape feature 34 has a slot depth 44 and a slot width 45. The slot depth 44 can be defined as the distance of the furthest point of the slotted shape feature 34 from the plane defined by the lateral surface 43. The slot width 45 can be defined as the maximum distance, measured along the direction of extent 51, between a first edge of the slotted shape feature 34 extending parallel to the thickness direction 53 and a second edge of the slotted shape feature 34 likewise extending parallel to the thickness direction 53. The slot depth 44 and the slot width 45 can each be greater than or equal to the wire diameter 48. The slot depth 44, the slot width 45 and an angle between the slot boundary surfaces 54 can be chosen so that the coil wire 12 can be routed through the slotted shape feature 34 in such a way that it does not project outward from the slotted shape feature 34 beyond a plane defined by the lateral surface 43. In this way, particularly reliable form-fitting support can be achieved.

The fixing arrangement can have a plurality of shape features formed on the contact pin 30 to provide form-fitting support of the coil wire 12. The plurality of shape features can have a plurality of shape features which are formed along the same lateral surface 43 and/or a plurality of shape features which are formed on different lateral surfaces of the contact pin 30, and these shape features are each dimensioned and arranged to provide form-fitting support to the coil wire 12.

FIG. 4 shows a configuration of the contact pin 30 in which the contact pin has a first row of a plurality of slots 61 and a second row of a plurality of slots 62. The first row of a plurality of slots 61 is formed in the lateral surface 43. The second row of a plurality of slots 62 is formed in a further lateral surface 49. Each of the slots 34 of the first and/or second row of slots 61, 62 can have a configuration as described, for example, with reference to FIG. 2 and FIG. 3.

In its end portion 13, the coil wire 12 is wound around the contact pin 30 in such a way that it runs multiple times around it along a helical path. In this case, the coil wire 12 is supported on the contact pin 30 in a form-fitting manner by one slot or advantageously by a plurality of slots of the first row of a plurality of slots 61. In addition, the coil wire 12 is supported on the contact pin 30 in a form-fitting manner by one slot or advantageously by a plurality of slots of the second row of a plurality of slots 62.

The fixing arrangement can not only have recesses relative to a plane of the lateral surface 43 of the contact pin 30. Alternatively or in addition, the fixing arrangement can have at least one projection and advantageously at least one pair of projections in order to support the coil wire 12 in a form-fitting manner in its end portion 13.

FIG. 5 is a schematic plan view of another configuration of the contact pin 30. The fixing arrangement has a shape feature which has a projection 63 and a further projection 64. The projection 63 and the further projection 64 can each be configured to support the coil wire 12 at least in a form-fitting manner on the contact pin 30 in such a way that the risk of a relative movement between the coil wire 12 and the lateral surface 43 along the direction of extent 51 is reduced. The projection 63 and the further projection 64 are arranged in such a way that the coil wire 12 can be routed through the intermediate space defined between the projection 63 and the further projection 64. The projection 63 and the further projection 64 can each have chamfered or curved surface regions in order to reduce or eliminate sharp edges in proximity to the coil wire 12.

The fixing arrangement which has the projection 63 and the further projection 64 can be matched to the coil wire 12. In particular, a height 66 of the projection 63 and of the further projection 64 can be chosen so that it is equal to or greater than the wire diameter 48. In this case, the height 66 can be determined as the distance by which the projection 63 and the further projection 64 project along the width direction 52 relative to a plane defined by the lateral surface 43. A spacing 65 between the projection 63 and the further projection 64 can be chosen so that it is equal to or greater than the wire diameter. In this case, the spacing 65 can be defined as the spacing between mutually parallel, mutually facing surfaces of the projection 63 and of the further projection, wherein the spacing is measured along the direction of extent. The spacing 65 can correspond to a clear width of the intermediate space between the projection 63 and the further projection 64.

The configuration features of the contact pin 30 which have been explained with reference to FIG. 2 to FIG. 5 and the interaction thereof with the end portion 13 can be employed in corresponding fashion for the further contact pin 30′ and the arrangement of the further end portion 14 in relation to the further contact pin 30′. It is not necessary for the contact pins 30, 30′ to have an identical configuration. It is advantageous but not absolutely necessary that each of the contact pins which is secured on one end portion of the coil wire by a welded joint and around which the coil wire is helically wound should have at least one shape feature for form-fitting support of the coil wire.

While FIG. 1 shows a 2/2-way valve, a vehicle component according to one exemplary embodiment may also have a solenoid valve with a different number of ports and/or valve positions.

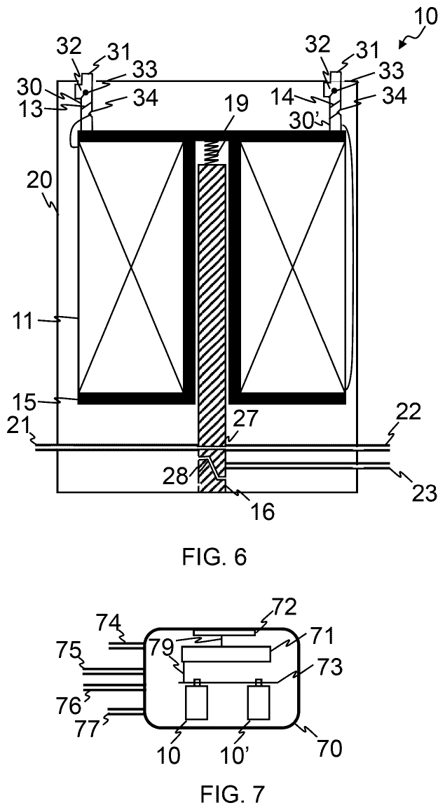

By way of example, FIG. 6 shows a vehicle component in the form of a solenoid valve 10 which is designed as a 3/2-way valve. The solenoid valve 10 has a contact pin 30 and a fixing arrangement which has a shape feature 34 of the contact pin 30 and is configured to support an end portion 13 of the coil wire in a form-fitting manner on the contact pin 30. The solenoid valve 10 has a further contact pin 30′, wherein the fixing arrangement has a further shape feature 34 of the further contact pin 30′ and is configured to support an end portion 14 of the coil wire in a form-fitting manner on the further contact pin 30′. In this case, the form-fitting support is in each case provided in a region of the contact pin 30 or of the further contact pin 30′ which is at a distance from the welding zone 32.

The solenoid valve 10 has a first port 21, a second port 22 and a third port 23. Fluid passages 27, 28 in the sealing body 16 are arranged and configured in such a way that, in a first valve position, the first port 21 is fluidically connected to the second port 22 via a first fluid passage 27 of the solenoid valve 10, while the third port 23 is sealed off. The solenoid valve is configured in such a way that, in a second valve position, the first port 21 is fluidically connected to the third port 23 via a second fluid passage 28 of the solenoid valve 10, while the second port 22 is sealed off. By energization of the coil 11, the solenoid valve can be switched between the first and the second valve position.

In addition to the solenoid valve 10 or to a plurality of solenoid valves 10, the vehicle component can have further components. In particular, the vehicle component can be configured as a vehicle component of an electropneumatic vehicle system. Vehicle components which have one or more solenoid valves 10 with a configuration according to one embodiment or one exemplary embodiment are described with reference to FIGS. 7-16.

FIG. 7 shows a schematic illustration of a vehicle component designed as an electropneumatic controller 70. The electropneumatic controller 70 has control electronics 71, an electronic interface 72, and a solenoid valve 10 or a plurality of solenoid valves 10, 10′. The solenoid valve 10 or the solenoid valves 10, 10′ have one or more solenoid valves with a configuration as described, for example, with reference to FIGS. 1-6 and as further described throughout the present disclosure.

The solenoid valve 10 or the solenoid valves 10, 10′ can be connected in an electrically conductive manner to the control electronics 71 via electrically conductive connections, which can be formed on a circuit board 73. The control electronics 71 are configured to supply current to the coils 11 of at least one solenoid valve 10, 10′ in accordance with input signals and/or input data received at the electronic interface 72 in order to change the valve position. Electronic interface 71 can be configured as a bus interface for connection to a vehicle bus.

The electropneumatic controller 70 has a compressed air inlet 74, which is configured for direct or indirect coupling to a compressed air source. The electropneumatic controller 70 has a consumer outlet 75, which is configured to output compressed air to a pneumatic consumer and/or to receive compressed air from the pneumatic consumer. The consumer outlet 75 can be coupled directly or indirectly to the pneumatic consumer. The electropneumatic controller 70 can have a vent opening 77 in order to vent the pneumatic consumer in a controlled manner via the electropneumatic controller. The control electronics 71 can be configured to control a state of at least one or more of the solenoid valves 10, 10′ in such a way that compressed air can be fed selectively to the pneumatic consumer via the electropneumatic controller 70, or the pneumatic consumer can be vented via the electropneumatic controller 70.

The electropneumatic controller 70 can be configured to supply compressed air to and/or to vent a plurality of pneumatic consumers. For this purpose, the electropneumatic controller 70 can have at least one further consumer outlet 76, which is configured to output compressed air to at least one further pneumatic consumer and/or to receive compressed air from the at least one further pneumatic consumer. The at least one further consumer outlet 76 can be coupled directly or indirectly to the at least one further pneumatic consumer.

The electropneumatic controller 70 has a reduced risk that it will fail and/or will have to be serviced due breakage of a coil wire of a solenoid valve.

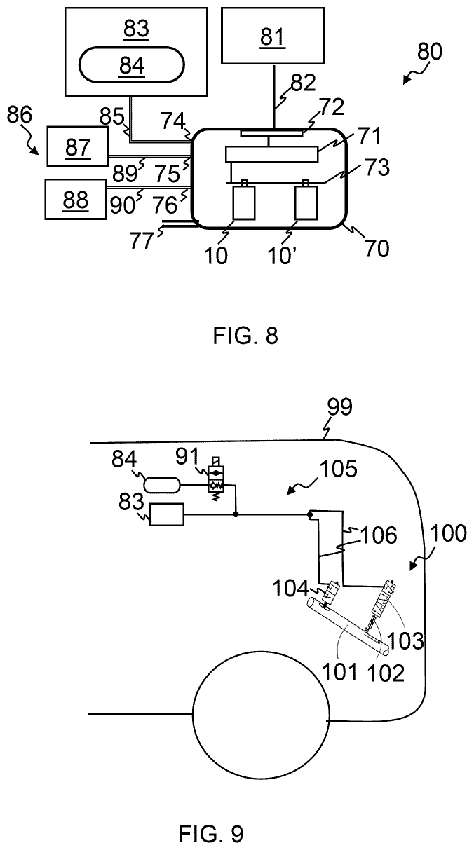

FIG. 8 is a schematic illustration of an electropneumatic vehicle system 80. The electropneumatic vehicle system 80 has the electropneumatic controller 70. The electropneumatic vehicle system 80 has a control unit 81, which is coupled to the electronic interface 72 via a signal or data link 82. The control unit 81 can be configured to provide signals or data to the electropneumatic controller 70 in accordance with user inputs and/or measured values acquired by way of one or more sensors. The electropneumatic controller 70 can be configured to control at least one of the solenoid valves 10, 10′ in accordance with the signals or data received from the control unit. The electropneumatic controller 70 can be configured to feed compressed air to an air consumer 87 of the electropneumatic vehicle system 80 in accordance with the signals or data received from the control unit or to vent said consumer and/or to feed compressed air to a further air consumer 88 of the electropneumatic vehicle system 80 or to vent said consumer. The electropneumatic vehicle system has a compressed gas supply installation 83 in order to supply the electropneumatic controller 70 with compressed air. The compressed gas supply installation 83 can have a compressed gas accumulator 84.

The electropneumatic vehicle system 80 has a pneumatic line system. The pneumatic line system has a supply line 85, which is connected to the compressed gas supply installation 83 and the electropneumatic controller 70 and via which the electropneumatic controller 70 can receive compressed air at the compressed gas inlet 74. The pneumatic line system has a consumer line 89, which is connected to the pneumatic consumer 87 and the electropneumatic controller 70 in order to supply the pneumatic consumer 87 with compressed gas and/or to vent said consumer. The pneumatic line system can have a further consumer line 90, which is connected to the at least one further pneumatic consumer 88 and the electropneumatic controller 70 in order to supply the at least one further pneumatic consumer 88 with compressed gas and/or to vent said consumer.

The electropneumatic vehicle system 80 can have an electropneumatic transmission system, an electropneumatic clutch system, an electropneumatic brake system, an air treatment system, an electropneumatic leveling system, an electropneumatic air spring system and/or an electropneumatic brake system.

The electropneumatic vehicle system 80 has a reduced risk that it will fail and/or will have to be serviced due to breakage of a coil wire of a solenoid valve.

FIG. 9 is a schematic illustration of a motor vehicle 99 having an electropneumatic vehicle system that has a pneumatic transmission shift system 100. The pneumatic transmission shift system 100 has a shifting shaft 101 and a plurality of valves, which are functionally coupled to the latter and may have a 3/2-way valve 103, a 3/3-way valve 104 and/or a gate locking valve 102. At least one of the valves 102, 103, 104 of the transmission shift system 100 is connected via feed connections 105, 106 to a compressed gas supply installation 83 and/or a compressed gas accumulator 84 in order to be supplied with compressed air. At least one of the valves 102, 103, 104 of the transmission shift system 100 has a solenoid valve 10 in which a fixing arrangement supports a coil wire of the solenoid valve 10 in a form-fitting manner on a contact pin in order to reduce the risk that the coil wire will break. Alternatively or in addition, a controllable valve 91, which is coupled between the compressed gas accumulator 84 or the air supply installation 83 and the valves 102, 103, 104, may have a solenoid valve 10 in which a fixing arrangement supports a coil wire of the solenoid valve 10 in a form-fitting manner on a contact pin in order to reduce the risk that the coil wire will break. The pneumatic transmission shift system 100 has a reduced risk that it will fail and/or will have to be serviced due to breakage of a coil wire of a solenoid valve.

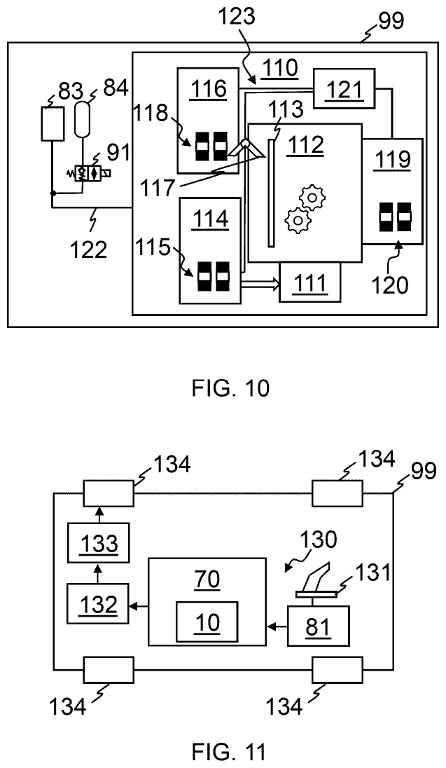

FIG. 10 is a schematic illustration of a motor vehicle 99 that has an automatic shift transmission 110. The automatic shift transmission 110 has a transmission 112 with a transmission shift rod 113, a clutch 111, which is coupled to the transmission 112, a selector device 114, a gear change device 116 and a transmission actuator 119. The automatic shift transmission 110 has one or more electronic control units 121, which are configured to control the selector device 114, the gear change device 116 and/or the transmission actuator 119. The automatic shift transmission 110 is supplied with compressed air via a supply line 122 by a compressed air supply installation 83 and/or a compressed gas accumulator 84. A controllable valve 91 can be controlled in order to exercise open-loop or closed-loop control over the supply.

The transmission 112 provides multiple gears. The transmission shift rod 113 makes it possible to shift between various gears. The clutch 111 is coupled to the transmission 112 and allows coupling and decoupling. This is accomplished through the use of the selector device 114, which can have a 2-position cylinder.

The selector device 114 is configured to provide compressed air to the clutch 111 for coupling and decoupling. The selector device 114 can have a first plurality of solenoid valves 115, e.g. two or four solenoid valves, which move a 2-position cylinder between two different functional positions.

The gear change device 116 can have a 3-position cylinder. The gear change device 116 can be configured to change between forward, reverse and neutral positions. For this purpose, the gear change device 116 can act on the transmission shift rod 113 via a lever 117. For adjustment of the 3-position cylinder, the gear change device 116 can have a second plurality of solenoid valves 118, e.g. four solenoid valves.

The transmission actuator 119 can be configured to control the actual shifting of the transmission 112. The transmission actuator 119 can have a third plurality of solenoid valves 120.

The automatic shift transmission 110 has at least one electronic control device 121 for controlling the selector device 114, the gear change device 116 and the transmission actuator 119. The control device 119 can be structurally integrated into one of these devices, e.g. into the selector device 114.

These various components of the automatic shift transmission system 110 interact in order to ensure efficient and reliable shifting of the transmission 112. The electronic control unit(s) 121 ensures or ensure precise control of the individual components.

At least one and advantageously all of the solenoid valves of the first plurality of solenoid valves 115, of the second plurality of solenoid valves 118 and/or of the third plurality of solenoid valves 120 have a configuration in which, as already explained and described with reference to FIGS. 1-6, a fixing arrangement supports the coil wire in a form-fitting manner on the contact pin in order to reduce the risk of a wire breaking. The automatic shift transmission 110 has a reduced risk that it will fail and/or will have to be serviced due to breakage of a coil wire of a solenoid valve.

FIG. 11 is a schematic illustration of a motor vehicle 99 that has a pneumatic hand brake system 130. The pneumatic hand brake system 130 has an actuating device 131, a control unit 81, an electropneumatic controller 70, a brake cylinder 132 and a parking brake 133, which is actuated by the brake cylinder 132 and acts on a wheel 134. The actuating device 131 can have a handle or some other mechanically actuable device, for example. The pneumatic hand brake system 130 is configured in such a way that the pneumatic hand brake system 130 is activated by mechanical actuation of the actuating device 131. In accordance with an actuation of the actuating device 131, the control unit 81 generates a signal or command data for the electropneumatic controller 70. The electropneumatic controller 70 has at least one solenoid valve 10 and is configured to supply current to the at least one solenoid valve 10 in accordance with the signal received from the control unit 81 or the command data received from the control unit 81. An output pressure of electropneumatic controller 70, which is provided via the solenoid valve 10, is fed to the brake cylinder 132. Triggered by an actuation of the actuating device 131, the electropneumatic controller 70 provides pressure, which actuates the brake cylinder 132. The brake cylinder 132, in turn, acts on the parking brake 133, which acts on a wheel 134. The actuation of the brake cylinder 132 activates the parking brake 133.

The pneumatic hand brake system 130 is configured in such a way that the pneumatic pressure mechanism generates a reliable and stable braking effect that can be activated quickly when required.

The solenoid valve 10 has a configuration in which, as already explained and described with reference to FIGS. 1-6, a fixing arrangement supports the coil wire in a form-fitting manner on a contact pin in order to reduce the risk of a wire breaking. The pneumatic hand brake system 130 has a reduced risk that it will fail and/or will have to be serviced due to breakage of a coil wire of a solenoid valve.

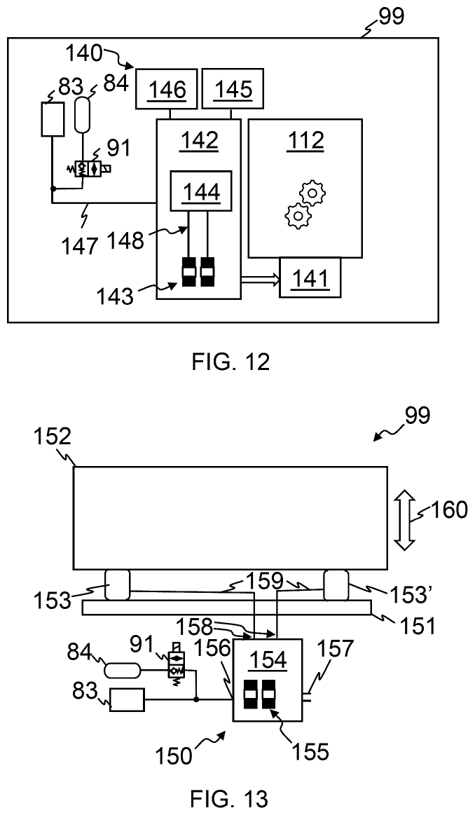

FIG. 12 is a schematic illustration of a motor vehicle 99 which has an electropneumatic clutch system 140 for actuating a pneumatically actuable clutch 141 for coupling and decoupling a transmission 112.

The electropneumatic clutch system 140 has an electropneumatic clutch actuating device 142. The electropneumatic clutch actuating device 142 is supplied with compressed air via a pneumatic supply line 147. The compressed air can be provided by a compressed gas supply installation 83 and/or a compressed gas accumulator 84. A controllable valve 91 can be controlled in order to exercise open-loop or closed-loop control over the compressed gas supply.

The electropneumatic clutch actuating device 142 has an electronic control unit 144 and at least one solenoid valve or a plurality of solenoid valves 143. The electronic control unit 144 is connected via electric connections 148 to the solenoid valve or the solenoid valves 143 in order to influence the valve position by selective energization. Depending on the valve position, the electropneumatic clutch actuating device 142 provides compressed gas to the clutch 141 in order to bring about coupling or decoupling. The electronic control unit 144 can be configured to control the solenoid valve or the solenoid valves 143 in accordance with signals or data which it receives from one or more sensors 145 and/or a controller 146.

At least one and advantageously all of the solenoid valves 143 have a configuration in which, as already explained and described with reference to FIG. 1 to FIG. 6, a fixing arrangement supports the coil wire in a form-fitting manner on a contact pin in order to reduce the risk of a wire breaking. The electropneumatic clutch system 140 has a reduced risk that it will fail and/or will have to be serviced due to breakage of a coil wire of a solenoid valve.

FIG. 13 is a schematic illustration of a motor vehicle 99 that has an electropneumatic cab leveling system 150. The electropneumatic cab leveling system 150 is configured to change an inclination of a cab 152 of the motor vehicle 99 relative to a chassis 151. The electropneumatic cab leveling system 150 has a pneumatic adjusting element 153 and a further pneumatic adjusting element 153′, which are each configured to adjust the inclination of the cab 152. The pneumatic adjusting element 153 and the further pneumatic adjusting element 153′ can be configured as inflatable gas bags. The electropneumatic cab leveling system 150 has an electropneumatic control device 154. The electropneumatic control device 154 has at least two solenoid valves 155. The electropneumatic control device 154 is configured to selectively energize the at least two solenoid valves 155 in such a way that compressed air received at a compressed gas inlet 156 can be fed to one or both of the pneumatic adjusting element 153 and the further pneumatic adjusting element 153′ and/or that one or both of the pneumatic adjusting element 153 and the further pneumatic adjusting element 153′ can be vented via a vent opening 157 of the electropneumatic control device 154. The electropneumatic control device 154 has compressed gas outlets 158, each of which is connected to one of the pneumatic adjusting elements 153, 153′ via a connecting line 159. Byway of said function, different regions of the cab 152 can be adjusted along an adjustment path 160 in order to adapt the inclination in such a way that the cab 152 has a desired alignment, e.g. is aligned perpendicularly to a direction of gravity even when the chassis 151 is tilted. The compressed air can be supplied in the manner already explained. The solenoid valves 155 can be controlled in a known manner in accordance with signals or data which the electropneumatic control device 154 receives via signal or data links from a control unit and/or sensors.

At least one and advantageously all of the solenoid valves 155 have a configuration in which, as already explained and described with reference to FIGS. 1-6, a fixing arrangement supports the coil wire in a form-fitting manner on a contact pin in order to reduce the risk of a wire breaking. The cab leveling system 150 has a reduced risk that it will fail and/or will have to be serviced due to breakage of a coil wire of a solenoid valve.

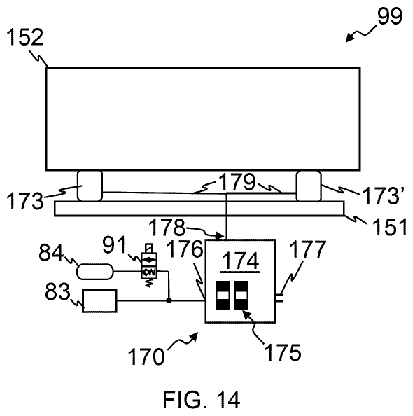

FIG. 14 is a schematic illustration of a motor vehicle 99 that has an electropneumatic shock damper system 170. The electropneumatic shock damper system 170 has a pneumatic shock damper 173 and a further pneumatic shock damper 173′, which are each arranged between a chassis 151 and a cab 152. The pneumatic shock damper 173 and the further pneumatic shock damper 173′ can be configured as gas bags, the pressure of which is adjustable. The electropneumatic shock damper system 170 has an electropneumatic control device 174. The electropneumatic control device 174 has at least one solenoid valve or a plurality of solenoid valves 175. The electropneumatic control device 174 is configured to selectively energize the at least one solenoid valve or the plurality of solenoid valves 175 in such a way that compressed air received at a compressed gas inlet 176 can be fed to the pneumatic shock damper 173 and the further pneumatic shock damper 173′ and/or that the pneumatic shock damper 173 and the further pneumatic shock damper 173′ can be vented via a vent opening 177 of the electropneumatic control device 174. The electropneumatic control device 174 has a compressed gas outlet 178, which is connected via a connecting line 179 to the pneumatic shock damper 173 and the further pneumatic shock damper 173′. By way of said function, a pressure in the shock dampers 173, 173′ can be subjected to open-loop or closed-loop control. The compressed air can be supplied in the manner already explained. The at least one solenoid valve or the plurality of solenoid valves 175 can be controlled in a known manner in accordance with signals or data which the electropneumatic control device 174 receives via signal or data links from a control unit and/or sensors.

At least one and advantageously all of the solenoid valves 175 have a configuration in which, as already explained and described with reference to FIGS. 1-6, a fixing arrangement supports the coil wire in a form-fitting manner on a contact pin in order to reduce the risk of a wire breaking. The shock damper system 170 has a reduced risk that it will fail and/or will have to be serviced due to breakage of a coil wire of a solenoid valve.

According to further exemplary embodiments, modulators that have at least one solenoid valve of the kind described here in detail are provided. Modulators according to exemplary embodiments can be employed in various ways, e.g. as modulators for supplying brake cylinders of a front axle or as rear axle modulators. Modulators according to exemplary embodiments can be employed, in particular, in pneumatic brake systems of commercial vehicles, advantageously also in pneumatic brake systems that have an electronic brake system (EBS).

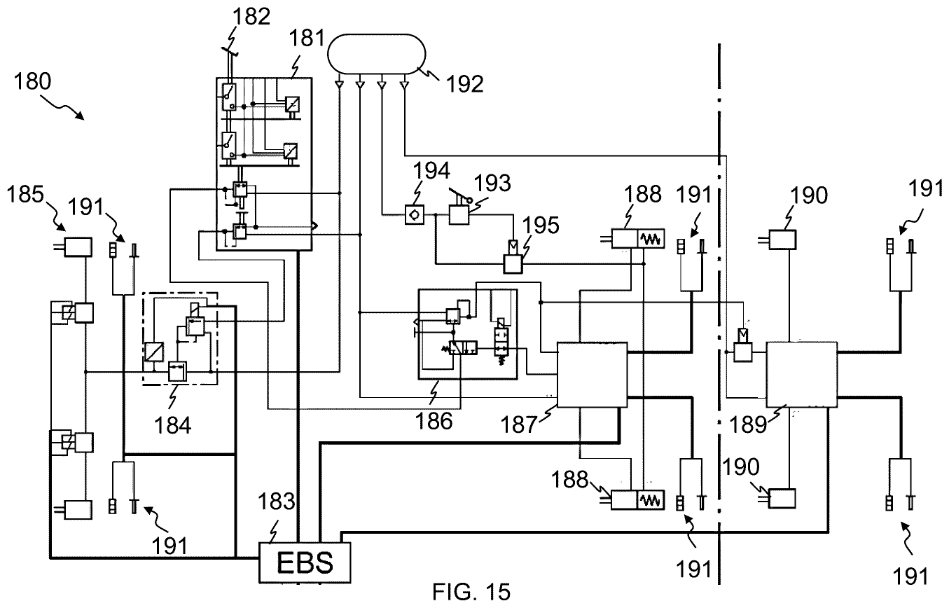

FIG. 15 shows an electropneumatic vehicle system configured as a brake system 180 in a schematic illustration. The brake system 180 has a brake signal transmitter 181. An actuating element 182, e.g. a pedal, can be arranged on the brake signal transmitter 181 or can be coupled therewith. An EBS 183 can be coupled to the brake signal transmitter 181 in order to generate commands for the brake signal transmitter 181 and/or the modulators 184, 187, 189 in accordance with sensor signals or sensor data acquired by way of sensors 191, for example.

The brake system has a plurality of modulators 184, 187, 189, which are each configured to convert a control pressure into a pressure in a working circuit. The modulator 184 can be configured and connected to increase a pressure in brake cylinders 185 of a front axle by connection to a compressed gas source or to reduce said pressure by venting. Alternatively or in addition, a modulator 187 can be provided which is designed as a rear axle modulator and is configured and connected to separately influence a pressure in brake cylinders 188 of a rear axle. Alternatively or in addition, a modulator 189 can be provided which is designed as a further rear axle modulator and is configured and connected to separately influence a pressure in further brake cylinders 190 of a further rear axle. One or more or all of the modulators 184, 187, 189 can have at least one solenoid valve, which has a coil and a contact pin, wherein a shape feature of the contact pin supports the coil wire in a form-fitting manner in an end portion of the coil wire on the contact pin. The brake system 180 has a reduced risk that it will fail and/or will have to be serviced due to breakage of a coil wire of a solenoid valve.

The brake system can have further components that are known per se. A compressed gas supply 192 can be arranged and connected to provide compressed gas or the pneumatic pressure to the compressed gas inlets of the modulators 184, 187, 189. Various pneumatic components, such as control valves 193, 195 or one or more check valves 194 can be arranged in the brake system.

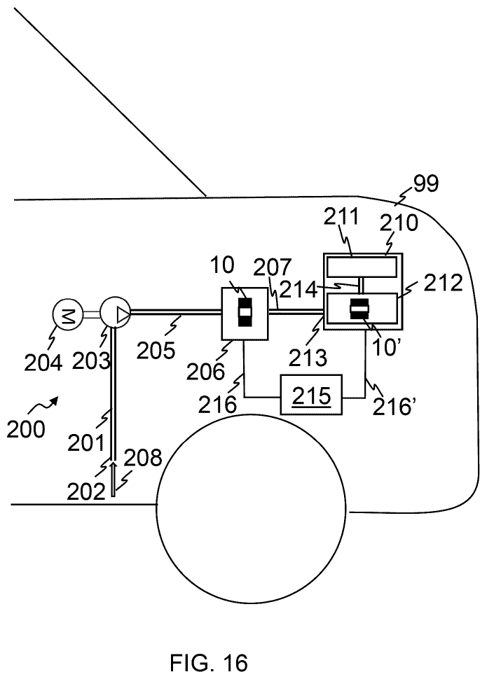

FIG. 16 shows a vehicle 99 that has an air treatment system 200 in a schematic illustration. The air treatment system 200 is configured to supply a consumer system 210 with air that has been treated by the air treatment system 200 (e.g. by drying, heating, cooling, pressure alteration). The air treatment system has an intake line 201 with an intake opening 202. A compressor 203, which can be driven by a drive 204, is configured to feed a flow 208 of induced air via a first connecting line to an electropneumatic intermediate system 206, which has at least one solenoid valve 10. The electropneumatic intermediate system 206 can be configured to treat the air, e.g. by drying, humidification, heating or cooling. The electropneumatic intermediate system 206 is configured to be controlled by at least one controller 215 via an electric connecting line 216 in order to carry out the desired treatment. The treated air is fed to the consumer system 210 via a second connecting line 207.

The consumer system 210 has an inlet 213 for receiving the treated air. The consumer system 210 has at least one air consumer 211. The consumer system 210 can have at least one electropneumatic device 212, which is configured to exercise open-loop or closed-loop control over a supply of the treated air from the inlet 213 to the at least one air consumer 211 via a third connecting line 214. The electropneumatic device 212 can have at least one further solenoid valve 10′.

The solenoid valves 10, 10′ have a configuration in which, as already explained and described with reference to FIGS. 1-6, a fixing arrangement supports the coil wire in a form-fitting manner on a contact pin in order to reduce the risk of a wire breaking. The vehicle system in FIG. 16 has a reduced risk that it will fail and/or will have to be serviced due to breakage of a coil wire of a solenoid valve.

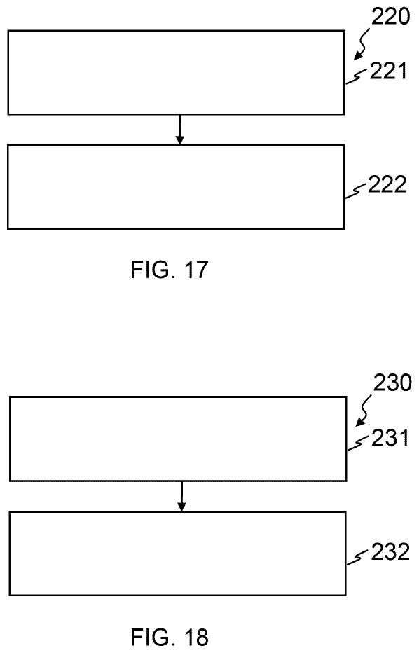

FIG. 17 is a flow diagram of a method 220 according to one embodiment.

The method 220 can be carried out by or with the vehicle component according to the present disclosure, the electropneumatic vehicle system according to the present disclosure, or the motor vehicle according to the present disclosure. The method 220 is a method for reducing the risk of breakage of a coil wire of a coil of a solenoid valve of a vehicle component.

In step 221, the coil wire is supported in a form-fitting manner in an end portion of the coil wire by at least one shape feature of a contact pin of the solenoid valve. The form-fitting support takes place in a region of the contact pin which is spaced away at a distance from and different from a welding zone in which the coil wire is welded onto the contact pin.

In step 222, a flow of current through the coil wire via the contact pin is selectively generated in order to change a valve position of the solenoid valve.

Further optional features of the method and the respective effects achieved thereby correspond to the features and effects explained with reference to the vehicle component, the electropneumatic vehicle system, and the motor vehicle.

FIG. 18 is a flow diagram of a method 230 according to one embodiment. The method 230 can be carried out in order to produce the vehicle component according to the present disclosure, the electropneumatic vehicle system according to the present disclosure, or the motor vehicle according to the present disclosure.

In step 231, a contact pin of a solenoid valve of the vehicle component is produced in such a way that the contact pin has a shape feature for the form-fitting support of a coil wire of the solenoid valve. The shape feature is arranged spaced away at a distance from and separately from a welding zone provided for securing the coil wire by way of a welded joint. The production of the contact pin can include punching the contact pin out of a metal sheet, e.g. out of a web of sheet metal. Punching can be performed in such a way that the shape feature is formed by the punching operation.

In step 232, an end portion of the coil wire is wound around the contact pin in such a way that the shape feature supports the coil wire in a form-fitting manner on the contact pin in the end portion.

The vehicle component, the electropneumatic vehicle system, the motor vehicle, and the method according to exemplary embodiments make it possible to reduce and/or eliminate the risk of wire breakage. The risk of a maintenance outage caused by a wire breaking can thus be reduced.

Thus, according to further embodiments of the present disclosure, the use of the vehicle component, of the electropneumatic vehicle system, of the commercial vehicle, and of the method according to one embodiment are also provided in order to reduce the risk of a wire breaking and/or to reduce a maintenance outage caused by a wire breaking.

The vehicle component, the electropneumatic vehicle system, the motor vehicle, and the method have been described with reference to the figures. Alterations and modifications can be implemented in further embodiments.

Illustrative further alterations of the embodiments disclosed in detail may include the following alterations, for example, without being restricted thereto: the solenoid valve does not have to be configured as a 2/2-way valve or as a 3/2-way valve but can have a different number of ports (e.g. three or four) and/or a different number of valve positions (e.g. three). The solenoid valve can be a 3/3-way valve, for example. While the vehicle component can be a component of an electropneumatic transmission system, of an electropneumatic clutch system, of an electropneumatic brake system, of an air treatment system, of an electropneumatic leveling system, of an electropneumatic air spring system or of an electropneumatic brake system, the vehicle component may also be a vehicle component of other systems, e.g. of a sensor cleaning system. The vehicle component and the electropneumatic vehicle system may be employed to particular advantage in a commercial vehicle since vibration-induced shocks and/or the time in use during which vehicle components are subject to shocks entail a particularly high risk that the coil wire will slip relative to the contact pin of the solenoid valve. However, use in passenger cars is also possible.

### List of Reference Signs (Part of the Description)

10 solenoid valve
10′ solenoid valve
11 coil
12 coil wire
13 end portion
14 further end portion
15 coil support
16 sealing body
17 sealing surface
18 valve seat
19 spring-elastic device
20 housing
21 first port
22 second port
23 third port
24 first fluid space
25 second fluid space
26 support element
27 first fluid connection
28 second fluid connection
30 contact pin
30′ further contact pin
31 terminal region
32 welding zone
33 welded joint
34 slotted shape feature
35 cover
36 region of the contact pin which is at a distance from the welding zone
41 main surface
42 further main surface
43 lateral surface
44 slot depth
45 slot width
46 sheet thickness
47 lowest point of the slot
48 wire diameter
49 further lateral surface
51 direction of extent
52 width direction
53 thickness direction
54 slot boundary surface
55 transitional surface
56 further transitional surface
57 contact pin width
58 further contact pin width
61 first row of slots
62 second row of slots
63 projection
64 further projection
65 spacing between projections
66 projection height
70 electropneumatic controller
71 control electronics
72 electronic interface
73 circuit board
74 compressed gas inlet
75 consumer outlet
76 further consumer outlet
77 vent opening
79 line paths
80 electropneumatic vehicle system
81 control unit
82 signal or data link
83 compressed gas supply installation
84 compressed gas accumulator
85 supply line
86 consumer system
87 pneumatic consumer
88 further pneumatic consumer
89 consumer line
90 further consumer line
91 controllable valve
99 motor vehicle
100 automatic shift transmission
101 shifting shaft
102 gate locking valve
103 3/2-way valve
104 3/3-way valve
105 pneumatic connection system
106 feed connection
110 automatic shift transmission system
111 clutch
112 transmission
113 transmission shift rod
114 selector device
115 first plurality of solenoid valves
116 gear change device
117 lever
118 second plurality of solenoid valves
119 transmission actuator
120 third plurality of solenoid valves
121 electronic control unit(s)
122 pneumatic supply line
123 electric connection(s)
130 electropneumatic hand brake system
131 actuating device
132 brake cylinder
133 parking brake
134 wheel
140 electropneumatic clutch system
141 pneumatically actuable clutch
142 electropneumatic clutch actuating device
143 solenoid valve(s)
144 electronic control unit
145 sensor(s)
146 controller
147 pneumatic supply line
148 electric connection(s)
150 electropneumatic cab leveling system
151 chassis
152 cab
153 pneumatic adjusting element
153′ further pneumatic adjusting element
154 electropneumatic control device
155 solenoid valve(s)
156 compressed gas inlet
157 vent opening
158 compressed gas outlet
159 pneumatic connecting line
160 adjustment path for leveling
170 electropneumatic shock damper system
173 pneumatic shock damper
173′ further pneumatic shock damper
174 electropneumatic control device
175 solenoid valve(s)
176 compressed gas inlet
177 vent opening
178 compressed gas outlet
179 pneumatic connecting line
180 pneumatic vehicle system
181 brake signal transmitter
182 actuating element
183 electronic brake system
184 modulator
185 front axle brake cylinder
186 redundancy valve
187 axle modulator
188 brake cylinder
189 further axle modulator
190 brake cylinder
191 sensors
192 compressed gas supply
193 control valve
194 check valve
195 further control valve
200 air treatment system
201 intake line
202 intake opening
203 compressor
204 drive
205 first connecting line
206 electropneumatic intermediate system
207 second connecting line
210 consumer system
211 air consumer
212 electropneumatic controller
213 inlet
214 third connecting line
215 electric controller(s)
216 electric connecting line
216′ further electric connecting line
220 method
221 method step
222 method step
230 method
231 method step
232 method step

1. A vehicle component (10; 70; 102-104; 114, 116, 119; 142; 154; 174; 184, 187, 189; 200, 210), comprising:
a solenoid valve (10; 10′) comprising:
a coil (11) having a coil wire (12) and
a contact pin (30, 30′) for electrical contacting of the coil wire (12),
wherein the contact pin (30, 30′) includes a welding zone (32),
wherein the coil wire is secured on the welding zone by a welded joint (33), and
a fixing arrangement (34; 61, 62; 63, 64) that mechanically fixes the coil wire (12) in a fixing region (36) of the contact pin (30, 30′), wherein the fixing region is located at a distance from the welded joint (33).

2. The vehicle component (10; 70; 102-104; 114, 116, 119; 142; 154; 174; 184, 187, 189; 200, 210) as claimed in claim 1, wherein the fixing arrangement (34; 61, 62; 63, 64) supports the coil wire (12) in a form-fitting manner on the fixing region (36).

3. The vehicle component (10; 70; 102-104; 114, 116, 119; 142; 154; 174; 184, 187, 189; 200, 210) as claimed in claim 1, wherein the fixing arrangement (34; 61, 62; 63, 64) has at least one shape feature (34; 61, 62; 63, 64), which is provided on the contact pin (30, 30′) and supports the coil wire (12) in a form-fitting manner.

4. The vehicle component (10; 70; 102-104; 114, 116, 119; 142; 154; 174; 184, 187, 189; 200, 210) as claimed in claim 3, wherein the at least one shape feature (34; 61, 62) is in the form of at least one recess (34; 61, 62) formed in the contact pin, wherein the coil wire (12) extends through the recess.

5. The vehicle component (10; 70; 102-104; 114, 116, 119; 142; 154; 174; 184, 187, 189; 200, 210) as claimed in claim 4, wherein the at least one recess (34; 61, 62) is in the form of a notch formed in the contact pin.

6. The vehicle component (10; 70; 102-104; 114, 116, 119; 142; 154; 174; 184, 187, 189; 200, 210) as claimed in claim 3, wherein the fixing arrangement (34; 61, 62; 63, 64) is in the form of a plurality of mutually spaced apart recesses (61, 62), wherein the coil wire (12) extends through each of the recesses.

7. The vehicle component (10; 70; 102-104; 114, 116, 119; 142; 154; 174; 184, 187, 189; 200, 210) as claimed in claim 1, wherein the contact pin (30, 30′) extends along a direction of extent (51), wherein the coil wire (12) extends in a helical shape around the contact pin and along the direction of extent (51) of the contact pin (30, 30′), wherein the fixing arrangement (34; 61, 62; 63, 64) reduces or prevents relative movement between the coil wire (12) and the contact pin (30, 30′) along the direction of extent (51).

8. The vehicle component (10; 70; 102-104; 114, 116, 119; 142; 154; 174; 184, 187, 189; 200, 210) as claimed in claim 7, wherein the contact pin (30, 30′) has a contact pin width (57, 58) measured in a width direction (52) extending transversely to the direction of extent (51), wherein, in the fixing region (36) of the contact pin (30, 30′) that is at a distance from the welded joint (33), the contact pin width (57, 58) varies as a function of a position along the direction of extent (51).

9. The vehicle component (10; 70; 102-104; 114, 116, 119; 142; 154; 174; 184, 187, 189; 200, 210) as claimed in claim 8, wherein the contact pin width (57, 58) exhibits a nonmonotonic change in the fixing region (36) of the contact pin (30, 30′) that is at a distance from the welded joint (33).

10. The vehicle component (10; 70; 102-104; 114, 116, 119; 142; 154; 174; 184, 187, 189; 200, 210) as claimed in claim 3, wherein the at least one shape feature (34; 61, 62) is in the form of projections (63,64) extending from the contact pin, wherein the coil wire (12) extends through an intermediate space defined between the projections.

11. The vehicle component (10; 70; 102-104; 114, 116, 119; 142; 154; 174; 184, 187, 189; 200, 210) as claimed in claim 3, wherein the at least one shape feature is formed in a lateral surface that extends along a direction of extent of the contact pin, and the at least one shape feature is sized such that the coil wire is received in the at least one shape feature without projecting beyond a plane defined by the lateral surface.

12. An electropneumatic vehicle system having the vehicle component (10; 70; 102-104; 114, 116, 119; 142; 154; 174; 184, 187, 189; 200, 210) as claimed in claim 1.

13. The electropneumatic vehicle system (80; 100; 110; 130; 140; 150; 170; 180; 200, 210) as claimed in claim 12, wherein the electropneumatic vehicle system (80; 100; 110; 130; 140; 150; 170; 180; 200, 210) includes an electropneumatic transmission system (100, 110), an electropneumatic clutch system (140), an electropneumatic brake system (130, 180), an air treatment system (200), an electropneumatic leveling system (150) and/or an electropneumatic air spring system (170).

14. A motor vehicle (99) having the vehicle component (10; 70; 102-104; 114, 116, 119; 142; 154; 174; 184, 187, 189; 200, 210) as claimed in claim 1.

15. A motor vehicle (99) having the electropneumatic vehicle system (80; 100; 110; 130; 140; 150; 170; 180; 200, 210) as claimed in claim 12.

16. A method for reducing a risk of breakage of a coil wire (12) of a solenoid valve (10; 10′) of a vehicle component (10; 70; 102-104; 114, 116, 119; 142; 154; 174; 184, 187, 189; 200, 210), wherein the solenoid valve (10; 10′) has a contact pin (30, 30′), wherein the contact pin (30, 30′) has a welding zone (32), and wherein the coil wire (12) is secured on the welding zone (32) by a welded joint (33), wherein the method comprises:
mechanically fixing the coil wire (12) in a region (36) of the contact pin (30, 30′) which is at a distance from the welded joint (33) in order to reduce or prevent a relative movement between the coil wire (12) and the contact pin (30, 30′) in the region (36) of the contact pin (30, 30′) which is at a distance from the welded joint (33).

17. The method as claimed in claim 16, further comprising: forming at least one shape feature (34; 61, 62; 63, 64) on the contact pin (30, 30′), wherein the at least one shape feature (34; 61, 62; 63, 64) is configured to support the coil wire (12) in a form-fitting manner, wherein the mechanical fixing comprises winding an end portion (13, 14) of the coil wire (12) helically around the contact pin (30, 30′) in such a way that the at least one shape feature (34; 61, 62; 63, 64) supports the coil wire (12) in a form-fitting manner.

18. The method as claimed in claim 17, wherein the at least one shape feature is in the form of a notch recessed into the contact pin or projections extending out of the contact pin.

19. A method for reducing a risk of breakage of a coil wire (12) of a solenoid valve (10; 10′) of the vehicle component (10; 70; 102-104; 114, 116, 119; 142; 154; 174; 184, 187, 189; 200, 210) of claim 1, wherein the method comprises:
mechanically fixing the coil wire (12) in the region (36) of the contact pin (30, 30′) that is at a distance from the welded joint (33) in order to reduce or prevent a relative movement between the coil wire (12) and the contact pin (30, 30′) in the region (36) of the contact pin (30, 30′) that is at a distance from the welded joint (33).

20. A method for reducing a risk of breakage of a coil wire (12) of a solenoid valve (10; 10′) of a vehicle component (10; 70; 102-104; 114, 116, 119; 142; 154; 174; 184, 187, 189; 200, 210) of the electropneumatic vehicle system (80; 100; 110; 130; 140; 150; 170; 180; 200, 210) as claimed in claim 12, wherein the method comprises:
mechanically fixing the coil wire (12) in the region (36) of the contact pin (30, 30′) which is at a distance from the welded joint (33) in order to reduce or prevent a relative movement between the coil wire (12) and the contact pin (30, 30′) in the region (36) of the contact pin (30, 30′) that is at a distance from the welded joint (33).
